(19) United States
(12) Patent Application Publication
(10) Pub. No.: US 2025/0276737 A1
(43) Pub. Date: Sep. 4, 2025

(54) FORESTRY TRAILER, IN PARTICULAR FOR TRANSPORTING OF TIMBERS

(71) Applicant: TAJFUN PLANINA PROIZVODNJA STROJEV, D.O.O., Planina pri Sevnici (SI)

(72) Inventor: Nejc ARZENSEK, Grobelno (SI)

(21) Appl. No.: 18/863,773

(22) PCT Filed: Mar. 28, 2023
(86) PCT No.: PCT/SI2023/000003

§ 371 Date: Nov. 7, 2024

(30) Foreign Application Priority Data
May 31, 2022 (SI) P-202200086

(51) Int. Cl. B62D 21/20; B62D 27/06; B62D 33/02

(52) U.S. Cl. CPC B62D 21/20; B62D 27/065; B62D 33/0215

(57) ABSTRACT

The present disclosure provides a trailer such as a tractor trailer suitable for transporting timber or other similarly shaped rigid linear parts. According to the present disclosure, the trailer comprises a bearing assembly (1), which is supported by a driving assembly (2), and is moreover furnished with a towing hitch (3) and at least two loading bridges (4, 4′, 4″), wherein said bearing assembly (1) is a uniform linear section of a square tube.

### CROSS-REFERENCE TO RELATED APPLICATIONS

This application is a United States national phase application of co-pending International Patent Application No. PCT/SI2023/000003, filed on 28 Mar. 2023, which claims the benefit of Slovenia Patent Application No. P-202200086 filed 31 May 2022, both of which are hereby incorporated by reference in their entirety.

### BACKGROUND

The present disclosure refers to transporting land vehicles, except for railway vehicles, and in particular trailers, such as tractor trailers. Pursuant to the International Patent Classification, such present disclosure should belong to the class B 62 D 53/06.

The present disclosure presents a forestry trailer suitable for transporting timber or similar stable and substantially linear cargo which may be in a bundle, wherein the trailer may be configured to enable application of typical components, which could be easily changed or adjusted based on the particular dimensions, shape, quantity, weight, and other aspects of the cargo which is expected to be transported by the trailer.

A trailer, which is suitable for transporting of timber in the field of forestry, is disclosed in DE 36 20 328 A1 and comprises a bearing assembly, which is formed of a part of I-beams, which are spaced apart from each other and are connected to form a uniform structure by means of transversal binding beams. A driving assembly with an axle and a pair of wheels placed thereon is mounted on bottom surfaces of said I-beams, which face towards the ground. Sufficiently rigid and U-shaped loading bridges, which are arranged transverse with respect to said I-beams and are spaced apart from each other in the longitudinal direction of said I-beams, are mounted in pre-determined positions on the top surfaces of said I-beams and are each furnished with a pair of vertical beams, which are firmly connected with said I-beams and extend in an upward direction, i.e. away from the ground. Consequently, such a trailer can be loaded with a certain amount of timber arranged between said vertical beams and which can be coupled to both terminal portions of said vertical beams secured by binding them in the form of a bundle, e.g. with a chain before transporting. As a consequence of this design, the trailer is substantially heavy, which can impact the ability of the trailer to transport additional cargo in view of a disposable power and weight of a semi-truck pulling the trailer. In addition to that, the configuration of the trailer is always determined in advance during the manufacturing process, which means that position of the driving assembly and arrangement of loading bridges with vertical beams are pre-determined and cannot be varied at all, so that adjusting the trailer to the actual needs of each particular user is possible only prior to finalization of the trailer during the manufacturing process, e.g. by providing various types of trailers with various lengths and various number or arrangements of loading bridges.

Moreover, a forestry trailer is disclosed in EP 3 106 347 B1, which is furnished with a mechanism for adjusting a driving assembly with wheels and which also comprises a bearing assembly, a driving assembly and loading bridges with vertical beams for securing the cargo to prevent it from being displaced in the transverse direction. Said bearing assembly is formed as a planar framework, consisting of a pair of rectangular tubes, which are parallel and spaced apart from each other and mutually connected to form a uniform bearing unit by transversal binding beams. Said rectangular tubes are oriented within the framework in such a manner that, when observed in their transversal cross-sections, the shorter sidewall of each of them extends parallel to the ground, while the longer sidewall of each of them extends perpendicular to the ground. Also, the transverse binding beams are in the form of rectangular tubes, parallel to each other and arranged along said pair of rectangular tubes which are also parallel to each other and oriented in the same manner. Consequently, such a framework is substantially rigid and is capable to withstand bending stresses in the longitudinal and transversal directions, and also torsion stresses around the central longitudinal geometric axis of the trailer, which extends through the trailer hitch.

Said driving assembly is a tandem assembly, which means that two wheels are available on each side of the trailer, which are each freely rotatable and mounted on the terminal portion of a pivoting beam, which is pivotally supported within a suitable housing by a central region of the pivoting beam. The housing with said pivoting beam and wheels on the one side of the trailer are firmly connected with the housing and with the associated pivoting beam and wheels on the other side of the trailer via a suitable transverse beam. Said housings are displaceable along said longitudinal rectangular tubes of the bearing framework along with the associated beams and wheels on both sides of the trailer, wherein a hydraulic cylinder is mounted adjacent to each longitudinal rectangular tube, which is connected with the housing of the pivoting beam with wheels as well as with one of said transversal binding beams of the bearing framework. Consequently, the position of the driving assembly along the bearing framework can be adjusted to the actual weight point of each particular cargo, wherein the driving assembly must then also be maintained in the adjusted position.

Positions of bearing bridges are also determined in advance for trailers according to EP 3 106 347 B1, and subsequent repositioning of bearing bridges to accommodate the actual needs of each particular user is not possible. Each loading bridge is positioned on its side facing the ground, and furnished with a pair of cylindrical protrusions which protrude towards the ground. Tubular seats are welded on the bearing framework at a suitable distance apart from each other, which are intended to receive said cylindrical protrusions. This means that a sufficient clearance i.e. a difference between the external diameter of the cylindrical protrusion and the inner diameter of the tubular seat must be provided, since unhindered placement of loading bridges would cause jamming. This may be particularly problematic during long-term use, where corrosion and impurities on the surface cannot be avoided. However, said clearance leaves some freedom to loading bridges within said seats, such that the loading bridges can be displaced within said seats, and in particular tilted forward or rearward with respect to the direction in which the trailer is moving. By moving an unloaded trailer, the loading bridges are randomly moved, tilted and vibrated, which generates noise, such that towing such trailer either in urbanized areas or in the forest may be problematic. Essentially, this concept does not allow for adjusting the positions of loading bridges, although it allows for adjusting the position of the driving assembly. Moreover, the configuration of the driving assembly cannot be modified at all, although in certain circumstances the presence of a single wheel on each side of the trailer would be quite sufficient.

Still further, a chassis for a semi-trailer is disclosed in US 2016/0311470 A1, which includes a telescopic bearing assembly, which functions as a uniform linear bearing member. In this case the bearing framework is formed from a pair of longitudinal tubes, which are spaced apart from each other and are firmly interconnected into a planar framework, which is then enclosed within a C-shaped profile by means of transverse binding beams. Such a framework is intended for mounting a transporting platform thereon and not for using loading bridges.

The present disclosure refers to a forestry trailer, in particular to a trailer for transporting of timber. Such a trailer generally comprises a bearing assembly, which is maintained at a sufficient distance apart from the ground and is supported by a driving assembly, which comprises at least one pair of mutually coaxial and freely rotatable wheels which are each arranged on lateral sides of the trailer. Said bearing assembly comprises a towing hitch in a first terminal area which is adapted for establishing a reliable, freely pivotal and optionally also detachable interconnection between the trailer and each disposable towing vehicle, in particular a tractor, the trailer hitch providing for maneuvering the trailer in various directions. Moreover, at least two substantially U-shaped loading bridges are mounted onto said bearing assembly and spaced apart from each other in the longitudinal direction of the trailer, each of them comprising a horizontal beam, which is sufficiently rigid to support the weight of the cargo, as well as a pair of vertical beams, which are in spaced apart from each other in the transverse direction of the trailer, and protrude in a direction away from the ground, and are capable for securing of a cargo, when it is arranged in form of a bundle, from falling down from the trailer in both lateral areas thereof. The position of said towing hitch on the bearing assembly is optionally changeable, and moreover, a mounting platform, which is suitable for attachment to a crane and/or a framework with a protective grid, is optionally mounted onto said bearing assembly.

The present disclosure proposes that said bearing assembly, which is supported by said driving assembly and is furnished with a towing hitch and at least two loading bridges arranged at a sufficient distance apart from each other in the longitudinal direction of the trailer forms a uniform longitudinal section of a square tube of a pre-determined length which is rotated 45° around its longitudinal geometric axis and is oriented such that the first diagonal of the transverse cross-section extends parallel to the ground, while the other diagonal extends perpendicular to the ground. Said driving assembly comprises a triangular i.e. V-shaped groove (observed in the transverse direction of the trailer), which is adapted to be disposed on the one side of said bearing assembly in the form of a square tube. The driving assembly also comprises a fastener, which is also furnished with a V-shaped groove and is adapted to be disposed on the opposite side of said bearing member, such that said fastener is connected to the driving assembly by means of screws, while the bearing assembly is held between the driving assembly and the fastener in the area of said V-shaped grooves.

Further, each of said loading bridges comprises a triangular i.e. V-shaped groove in the central area of its horizonal beam (when observed in the transverse direction of the trailer), which is adapted to be disposed on the one side of said bearing assembly, and is moreover furnished with a fastener, which also comprises a V-shaped groove, which is adapted to be disposed on the opposite side of said bearing assembly, such that said fastener is connected to the horizontal beam of the loading bridge, while the bearing assembly is held between the loading bridge and said fastener in the area of said grooves.

In the one of the embodiments of the present disclosure, a secondary bearing member is also provided, which is tightly insertable into said square tubular bearing assembly on the second terminal area thereof, which is located opposite said first terminal area with the towing hitch, wherein said secondary bearing member is a linear section of a square tube and is displaceable along said bearing assembly, upon which it may be fixed in each desired position. Said secondary bearing member is preferably fixed in each desired position relative to the bearing assembly by means of screws. Said secondary bearing member is preferably also adapted for receiving at least one loading bridge, which is furnished with a V-shaped groove and is attached to it by means of a fastener with a V-shaped groove, namely by means of screws, which serve for interconnecting said loading bridge and the fastener, by which the secondary bearing member is held between the loading bridge and the fastener.

The loading bridge, which is located opposite the towing hitch, is furnished with a light signaling unit, which is located in the area of its horizontal beam and facing in a direction away from the towing hitch, and is in the area of the towing hitch electrically connectable with a towing vehicle.

Said trailer is in the first terminal area of the bearing assembly, where the towing hitch is located, optionally furnished with a substantially box-shaped coupling casing, by which said square tube of the bearing assembly is enclosed by at least two sides thereof. Said coupling casing comprises two horizontally oriented binding plates, which are arranged one above the other and extend parallel to each other. These binding plates may include a top binding plate and a bottom binding plate, which each abut corresponding corners of said square tubular bearing assembly furnished with grooves, and at least four positioning spacers are inserted between said plates, such that each of said spacers is screwed both to the top binding plate and also to the bottom binding plate. Each of said spacers is furnished with a centrally arranged groove, which is adapted to fit with a rectangular corner area of an adjacent edge of the square tubular bearing assembly, and moreover, said positioning spacers are arranged in such a manner that at least two positioning spacers, which are sufficiently spaced apart from each other, are disposed on each side of said bearing assembly.

Said top binding plate of the mounting casing is adapted for supporting a mounting plate, which is placed directly on it and also screwed onto it. In one possible embodiment of the trailer, said mounting plate is adapted for attachment of a crane, which is screwed onto said mounting plate. The present disclosure further provides an embodiment in which said mounting plate is adapted for receiving a framework with a protecting grid, which is attachable to said mounting plate by means of screws. In addition, the trailer according to the present disclosure can also be furnished with a telescopic supporting leg, which is extendable in a direction towards the ground and is adapted to rest on the ground, and which is, similar to the driving assembly and the loading bridges, furnished with triangular i.e. V-shaped groove, which is adapted to be placed onto the one side of said square tubular bearing assembly. The telescopic supporting leg may also comprise a fastener which is also equipped with a V-shaped groove and adapted to be placed on the opposite side of said bearing assembly, such that said fastener is connected to the supporting leg with screws, and the bearing assembly is held between the supporting leg and its corresponding fastener in the area of both previously mentioned V-shaped grooves.

### BRIEF DESCRIPTION OF THE DRAWINGS

The present disclosure will be described in more detail on the basis of embodiments, as presented in the attached drawings, wherein:

FIG. 1 is a forestry trailer according to the present disclosure, namely a ready-to-use tractor trailer for transporting timber, presented in isometric view;

FIG. 2 is a trailer furnished with a chassis and wheels, also in isometric view;

FIG. 3 is a trailer according to FIG. 2, presented in orthogonal rear view;

FIG. 4 presents a detail A according to FIG. 3;

FIG. 5 presents a detail B according to FIG. 3;

FIG. 6 presents a loading bridge, in isometric view;

FIG. 7 presents a loading bridge according to FIG. 6, in front view;

FIG. 8 presents a detail C according to FIG. 7;

FIG. 9 presents a trailer coupling casing according to FIG. 2, in isometric view;

FIG. 10 is a cross-section along the plane III-III according to FIG. 9;

FIG. 11 is a further embodiment of the trailer according to FIG. 1, namely a trailer coupling casing according to FIG. 9 together with a crane mounting platform, in isometric view;

FIG. 12 is a cross-section along the plane I-I according to FIG. 11;

FIG. 13 is a cross-section along the plane II-II according to FIG. 11;

FIG. 14 presents a trailer coupling casing together with a crane mounting platform, again in isometric view, however at different angle as in FIG. 11;

FIG. 15 presents a trailer coupling casing together with a crane mounting platform and a towing hitch, in isometric view; and

FIG. 16 presents a still further embodiment of a trailer with adjustable towing hitch.

### DETAILED DESCRIPTION

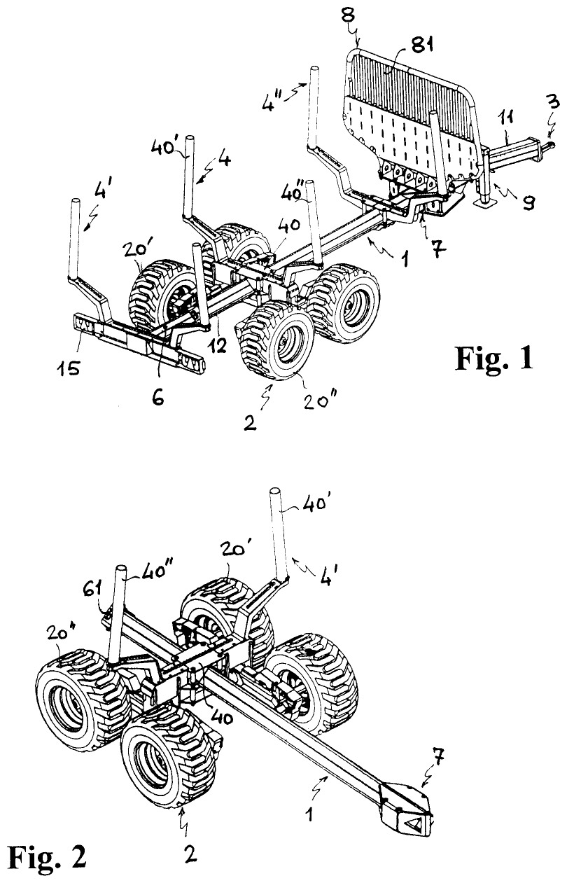

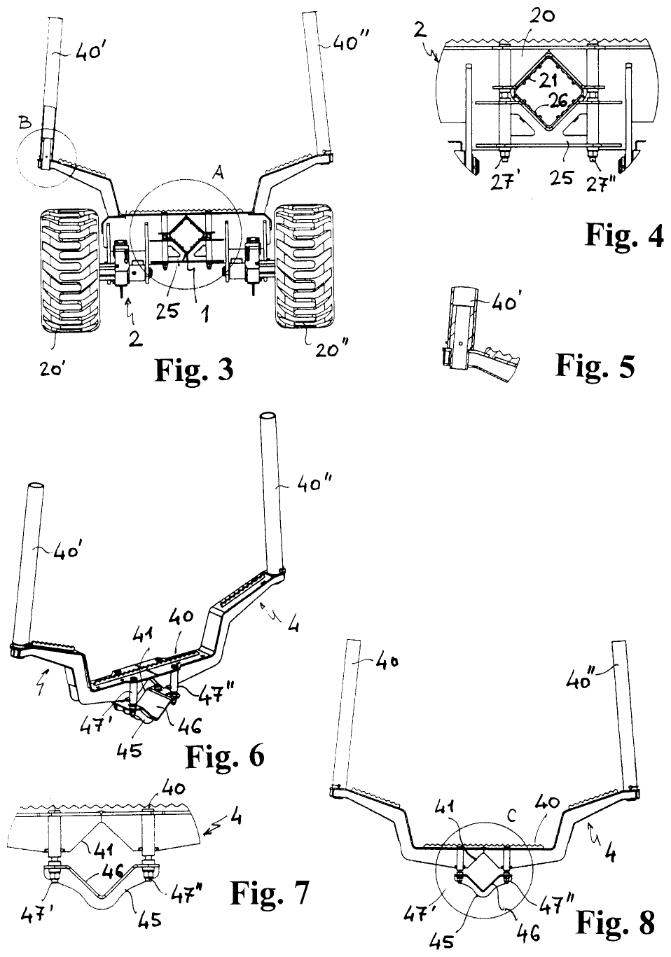

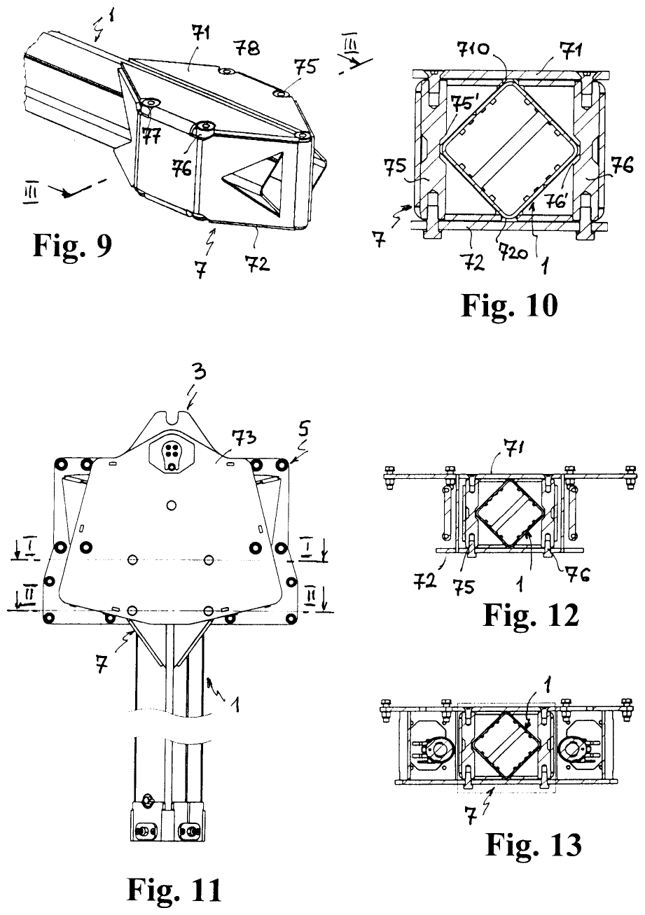

A forestry trailer, in particular a tractor trailer, which is suitable for transporting of timbers, and which is appropriately configured and in its ready-to-use state presented in FIG. 1, comprises a bearing assembly 1, which is at a suitable distance apart from the ground (FIG. 3) supported by means of a driving assembly 2, which generally comprises at least a pair of coaxially arranged and freely rotatable wheels 20′, 20″, which are each arranged laterally on each side of the trailer, although in the shown embodiment there are two wheels 20′, 20″ arranged on each side of the trailer, which are arranged one behind the other. Said driving assembly 2, without limitation to the present disclosure as such, may also include any other possible combination in view of the arrangement of said wheels 20′, 20″.

Said bearing assembly 1 is in its first terminal area 11 furnished with a towing hitch 3, which is adapted for establishing of a reliable and detachable mutual interconnection between the trailer and a towing vehicle, in particular a semi-truck, wherein said interconnection allows freedom of motion in order to enable maneuvers of the trailer during towing. Moreover, at least two substantially U-shaped loading bridges 4, 4′, 4″ are mounted on said bearing assembly 1 and are suitably spaced apart from each other in the longitudinal direction of said loading assembly 1. As shown, there are three loading bridges 4, 4′, 4″ each comprising a horizontal beam 40 sufficiently rigid to support the weight of the cargo, as well as a pair of vertical beams 40′, 40″, which extend up from the direction of the ground and are spaced apart from each other in a transverse direction to the trailer and are adapted to protect the cargo (even when bound in a bundle) against undesired lateral removal from the trailer.

The position of said towing hitch 3 on said bearing assembly 1 may optionally also be changed. In one embodiment of the trailer, which is shown in FIG. 16, the towing hitch 3 may also be repositioned at certain angles relative to the longitudinal geometric axis of the trailer, by which the radius of the wheel path is changed, which results in changing the direction of travel of the wheels 20′, 20″ to avoid obstacles.

Moreover, a mounting platform 5 can be optionally attached onto said bearing assembly 1, which serves for mounting a crane and/or a framework 8 with a protective grid 81 which is explained below in more detail.

Said bearing assembly 1, which is supported by the driving assembly 2 and furnished with said towing hitch 3 and said loading bridges 4, 4′, 4″, which are spaced apart from each other in the longitudinal direction of said bearing assembly 1, is according to the present disclosure conceived as a uniform longitudinal section of a straight square tube having a pre-determined length turned at 45° around its longitudinal geometric axis and oriented in such a manner that the first diagonal of its square cross-section extends parallel to the ground, while the other diagonal extends perpendicular to the ground.

Consequently, said driving assembly 2 comprises a triangular i.e. V-shaped groove 21 in its central area 20 (when observed in the transverse direction of the trailer), which is adapted to be placed on the one side of said bearing assembly 1 in form of a square tube, and is moreover equipped with a fastener 25, which is also furnished with a V-shaped groove, which is intended to be placed on the opposite side of said bearing assembly 1. Said fastener 25 is attached to the driving assembly 2 by means of screws 27′ 27″, such that the bearing assembly 1 is firmly clamped between the driving means 2 and the fastener 25 in the area between said grooves 21, 26.

Moreover, each of said loading bridges 4, 4′, 4″ comprises a triangular i.e. V-shaped groove 41 in a central area of its horizontal beam 40 (when observed in the transverse direction of the trailer), which is adapted to be disposed on the one side of said bearing assembly 1 in the form of a square tube, and is moreover equipped with a fastener 45, which is also furnished with a V-shaped groove 46, which is adapted to be placed on the opposite side of said bearing assembly 1, such that said fastener 45 is connected to horizontal beam 40 of the loading bridge 4, 4′, 4″ with screws 47′, 47″, while the bearing assembly 1 is clamped between the loading bridge 4, 4′, 4″ and the clamp 45 in the area of said grooves 41, 46.

As shown in FIG. 1, a secondary bearing member 6 in the form of a square tube can be optionally be inserted tightly into said bearing member 1 in form of square tube in the one terminal area 12 thereof, which is located opposite to the other terminal area 11 with the towing hitch 3, wherein said secondary bearing member 6 is also provided as a longitudinal section of a straight square tube and is displaceable along the bearing assembly 1, but can also be fixed in each desired position. In the embodiment shown, said secondary bearing member 6 is fixed in each desired position by means of screws 61, which are available in suitable threaded bores on said tubular bearing member 1. It should however be clear to a person skilled in the art that a fixation of said secondary bearing member 6 in each desired position to prevent further movement along the bearing assembly 1 can also be achieved in other ways. Said secondary bearing member 6 is, similarly like the bearing assembly 1 itself, adapted for receiving at least one loading bridge 4′ with a V-shaped groove 41, which may be mounted thereon by means of a fastener 45 with a V-shaped groove 46 and establishing an interconnection therebetween by means of suitable screws 47′, 47″, such that said secondary bearing member 6 is clamped between the horizontal area of said loading bridge 4′ and the corresponding fastener 45.

Whenever the trailer is prepared for road transporting, the loading bridge 4, 4′, 4″, which is located opposite the towing hitch 3. The loading bridge 4, 4′, 4″ may be equipped with at least one light signaling unit 15, which is preferably located in the horizontal area thereof and on the side facing away from the towing hitch 3, the light signaling unit 15 being electrically connectable with each disposable towing vehicle in the area of said towing hitch 3.

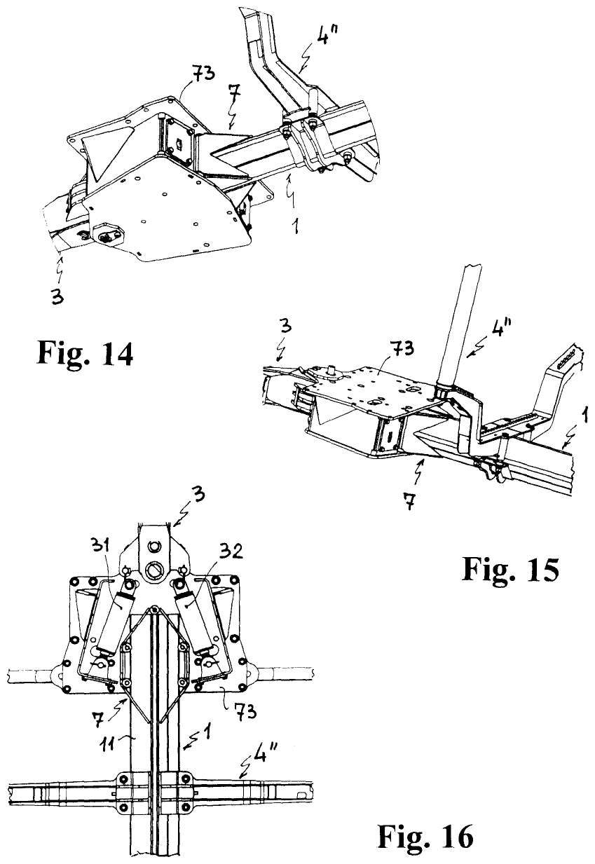

Still further, the trailer includes a substantially box-shaped trailer coupling casing 7 (FIG. 2) in the terminal area 11 of the bearing assembly 1 in which the towing hitch 3 is mounted, by which said square tube of the bearing assembly 1 is enclosed on least two opposite sides thereof. Said trailer coupling casing 7 may be used when the bearing assembly 1 is exposed to various forces coming from different directions, which may also change during use. As shown in FIGS. 10-15, said trailer coupling casing 7 comprises two sufficiently rigid binding plates 71, 72—including the first binding plate 71 and the second binding plate 72, which are arranged in parallel above each other and are each in contact with the corresponding corner of the square tubular bearing assembly 1 furnished with suitable grooves 710, 720. Four positioning spacers 75, 76, 77, 78 may also be included between binding plates 71, 72, which are each connected both with the top binding plate 71 and the bottom binding plate 72 with screws. Each of said spacers 75, 76, 77, 78 includes a centrally arranged groove 75′, 76′ which is adapted to receive a corresponding rectangular corner area of said square tubular bearing assembly 1. Accordingly, spacers 75, 76, 77, 78 are arranged in such manner so that on each side of said bearing assembly 1 at least two spacers 75, 76, 77, 78 are disposed and sufficiently spaced apart from each other. Moreover, said trailer coupling casing 7 is protected against undesired displacement in the longitudinal direction of the bearing assembly 1 by a transverse pin or other suitable device.

The top binding plate 71 of said trailer coupling casing 7 is adapted for receiving a mounting plate 73, or optionally a suitable plane frame, which is placed and screwed directly thereon. Such mounting late 73 can be adapted for mounting a crane, which is screwed onto the mounting plate 73. A foldable hydraulic crane, comprising a column with an arm, optionally a telescopic one, which is attached to said column, and suitable supporting legs, such that the bearing assembly 1 of trailer is required just to bear the weight of the crane itself, such that during the use of the crane the weight of each load and temporarily also the weight of the crane can be completely transferred the ground by means of said supporting legs.

In the embodiment shown according to FIG. 1, said mounting plate 73 is also adapted for receiving a framework 8 with an integrated protecting grid 81, wherein said framework 8 is also screwed onto the mounting plate 73. Said protective grid 81 is suitable for providing a safe area behind said grid 81 during manipulating a load in or around the trailer, to protect against potential collisions between the load and the user or the towing vehicle.

The trailer according to FIG. 1 further comprises at least one supporting leg 9, which is, similar to said driving assembly 2 and loading bridges 4, 4′, 4″, furnished with a V-shaped groove, which is adapted to be placed on the one side of said bearing assembly 1 in the form of a square tube, and moreover also comprises a suitable fastener, which is also furnished with a V-shaped groove and is located on the opposite side of said bearing assembly 1, such that said fastener is connected to the supporting leg 9 with screws, and that the bearing assembly 1 held between the supporting leg 9 and the corresponding fastener in the area of the V-shaped grooves. Said supporting leg 9 may be used when parking a loaded trailer, wherein undesired rotation of the trailer around the axis of wheels 20′, 20″ can be limited such that the towing hitch 3 is still maintained at a desired distance above the ground. The supporting leg 9 may also be used when parking an unloaded trailer, since the supporting leg 9, when resting on the ground, prevents the trailer from uncontrolled displacement in the longitudinal direction.

Those skilled in the art will understand that the embodiments of trailers herein allows for the application of typical components like said square tubular bearing assembly 1, which is optionally furnished also with a secondary bearing member 6, said loading bridges 4, 4′, 4″, said mounting casing 7 with the mounting plate 73 suitable for mounting a crane and/or a framework 8 with a protective grid 81, said supporting leg 9 and the towing hitch 3. The position of any of these components may be varied (FIG. 16) by means of hydraulic cylinders 31, 32 at a pre-determined angle displaced apart from the longitudinal geometric axis of the trailer in order to improve maneuverability of the trailer and avoiding collisions with various obstacles on the ground. Those skilled in the art will also understand that the number of components and also the position thereof may be determined based on the needs of each particular user and the size and shape of the cargo to be transported.

What is claimed is:

1. A forestry trailer, suitable for transporting timber, comprising:
a bearing assembly supported by a driving assembly comprising at least one pair of mutually coaxial and freely rotatable wheels, which are arranged on each lateral side of the trailer, wherein said bearing assembly includes a towing hitch in a first terminal area, which is adapted for establishing a pivotable and detachable interconnection between the trailer and a towing vehicle;
at least two U-shaped loading bridges mounted on said bearing assembly, the U-shaped loading bridges being spaced apart from each other in a longitudinal direction, wherein each of the U-shaped loading bridges comprises a horizontal beam sufficiently rigid to support cargo, and a pair of vertical beams spaced apart from each other in a transverse direction, the vertical beams extending up from the ground and are capable for securing the cargo from falling down from the trailer, wherein a position of said towing hitch on the bearing assembly is changeable;
a mounting platform configured to mount a crane and/or a framework with a protective grid, the mounting platform mounted on said bearing assembly, wherein said bearing assembly is supported by said driving assembly and includes a towing hitch;
at least two loading bridges which are spaced apart from each other in the longitudinal direction each of the loading bridges comprising a uniform longitudinal section of a square tube of a pre-determined length which is rotated at 45° around its longitudinal geometric axis and oriented such that a first diagonal of a transverse cross-section of the loading bridge extends parallel to the ground, while a second diagonal extends perpendicular to the ground, wherein said driving assembly comprises a first V-shaped groove in a central area of the driving assembly, the first V-shaped groove adapted to be placed on a first side of said bearing assembly forming a square tube, the driving assembly further comprising a first fastener; comprising a second V-shaped groove adapted to be placed on a second side opposite the first side of said bearing assembly such that said first fastener is connected to the driving assembly, while the bearing assembly is held between the driving assembly and the first fastener, and wherein each loading bridge comprises a third V-shaped groove adapted to be placed on the first side of the bearing assembly, each loading bridge comprising a second fastener comprising a fourth V-shaped groove adapted to be placed on the second side of said bearing assembly such that said second fastener is connected to the horizontal beam of the loading bridge, and the bearing assembly is held between the loading bridge and the second fastener in the area of the third and fourth V-shaped grooves.

2. The trailer of claim 1, further comprising a secondary bearing member that is insertable into said square tube of the bearing assembly within a second terminal area located opposite the first terminal area with the towing hitch, wherein said secondary bearing member comprises a linear section of square tube and is displaceable along said bearing assembly, the secondary bearing member also configured to be fixed in various desired positions.

3. The trailer of claim 2, wherein the secondary bearing member is fixed in the various desired positions with screws.

4. The trailer of claim 2, wherein said secondary bearing member is adapted for receiving the at least one loading bridge.

5. The trailer of claim 2, wherein each of the at least one loading bridge which comprises a light signaling unit disposed on the horizontal beam, the light signaling unit facing away from the towing hitch and electrically connectable to the towing vehicle.

6. The trailer of claim 2, further comprising a substantially box-shaped coupling casing in the terminal area of the bearing assembly, by which said square tube of the bearing assembly is enclosed by at least two sides thereof, wherein said coupling casing comprises two horizontally oriented binding plates arranged one above the other and extending parallel to each other, the binding plates comprising a top binding plate and a bottom binding plate; and
at least four positioning spacers inserted between said binding plates such that each one of said positioning spacers is screwed to the top binding plate and the bottom binding plate, wherein each of the said positioning spacers comprises a centrally arranged groove that corresponds with a rectangular corner area of each adjacent edge of the square tube of the bearing assembly, wherein at least two positioning spacers are positioned on each of the first and second sides of said bearing assembly and spaced apart from each other.

7. The trailer of claim 6, wherein said top binding plate is adapted for supporting a mounting plate, which is placed directly on it and screwed onto it.

8. The trailer of claim 7, wherein said mounting plate is attached to a crane, which is screwed onto said mounting plate.

9. The trailer of claim 7, wherein said mounting plate is adapted for receiving a framework with a protecting grid, which is attachable to said mounting plate by screws.

10. The trailer of claim 2, further comprising a telescopic supporting leg, which is extendable towards the ground and is adapted to be placed on the ground, the telescopic supporting leg comprising a fifth V-shaped groove, which is adapted to be placed on the first side of said square tube of the bearing assembly and a third fastener comprising a sixth V-shaped groove and adapted to be placed on the second side of said bearing assembly.
